(19) United States
(12) Patent Application Publication
(10) Pub. No.: US 2021/0014418 A1
(43) Pub. Date: Jan. 14, 2021

(54) Method of generating a real time panoramic image

(71) Applicant: Himanshu Kaul, Cedar Park, TX (US)

(72) Inventor: Himanshu Kaul, Cedar Park, TX (US)

(21) Appl. No.: 16/508,315

(22) Filed: Jul. 11, 2019

(51) Int. Cl. H04N 5/232; G06T 3/40

(52) U.S. Cl. CPC H04N 5/23238; H04N 5/23203; H04N 5/23299; G06T 3/4038

(57) ABSTRACT

The present invention is related to a method of generating a real time panoramic image comprising: capturing at least one media content by a rotatable camera, optionally of a voice-controlled device, wherein the rotatable camera, operable by a motor signal of a motor, is enabled to capture at least one media content at a given motor signal, extracting at least one feature of the at least one captured media content, associating the at least one captured media content with the given motor signal and the extracted at least one feature of the at least one captured media content and the real time stitching of the at least one captured media content based on the associated given motor signal and the associated extracted at least one feature to create the panoramic image.

### FIELD OF THE INVENTION

The present invention is related to a panoramic image, and more particularly to a method of generating a panoramic image using motor signals.

### BACKGROUND OF THE INVENTION

With advancements in digital image photography, generation of a panoramic image of a scene has attracted a lot of research. The panoramic image is created by capturing images of two or more adjacent view and then combining the images, such as by stitching the images together.

Panoramic images have a wide angle of view that is wider than the angle of view of a camera of electronic devices e.g. tablets, smartphones, computers, etc. Traditionally a user holds the device and moves it manually across the subject to take multiple images for creating a panoramic image. Users take images until the whole intended field of view of the subject is covered. This process is complex as changing the position of the device also increases the difficulty of stitching of the images to make a panoramic image. Additionally, the field of view (FOV) of cameras in electronic devices is typically very narrow.

The stitching of the images involves adjusting values of pixels in reference and target images, such that when the images are joined, the transition from one image to the other image is invisible. However, this process is very cumbersome and time-consuming.

Panoramic images are widely used in still photography. Nowadays, the stitching of images involves feature extraction from the multiple images, matching those features using feature matcher in reference and target images and generating a panoramic image. However, the image processing for feature extraction is a time and power consuming task.

Presently there is a prior art US10021296 discloses a method and apparatus to create a panoramic image via a rotating camera of a portable electronic device. The method includes rotating the camera of the portable electronic device with respect to the portable electronic device. The method further includes recording a plurality of images at a plurality of corresponding angles between the camera and a direction of the portable electronic device. The method further includes stitching the plurality of images together based on the plurality of angles and creating a panoramic image from the plurality of images.

Thus there remains a need to overcome the above-mentioned prior art.

### SUMMARY OF THE INVENTION

The present invention is related to a method of generating a real time panoramic image comprising: capturing at least one media content by a rotatable camera, optionally of a voice-controlled device, wherein the rotatable camera, operable by a motor signal of a motor, is enabled to capture at least one media content at a given motor signal, extracting at least one feature of the at least one captured media content, associating the at least one captured media content with the given motor signal and the extracted at least one feature of the at least one captured media content and the real time stitching of the at least one captured media content based on the associated given motor signal and the associated extracted at least one feature to create the panoramic image.

The method of generating a real time panoramic image combines feature extraction with the given motor signal to generate a continuous panoramic image.

### BRIEF DESCRIPTION OF THE DRAWINGS

The following drawings illustrates exemplary embodiment; however, they are helpful in illustrating objects, features and advantages of the present invention because the present invention will be more apparent from the following detailed description taken in conjunction with accompanying drawings in which:

FIG. 1 illustrates the flow chart of the method of generating a real time panoramic image according to the preferred embodiment of the present invention.

### DETAILED DESCRIPTION OF THE INVENTION

The present computer-implemented process will be more completely understood through the following detailed description which should be read in conjunction with the attached drawing in which similar reference numbers indicate similar structures. All references cited above and in the following description are hereby expressly incorporated by reference.

Reference will now be made in detail to the exemplary embodiment (s) of the invention. References to “one embodiment,” “at least one embodiment;” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation.

The panoramic image can be generated from the images captured by a rotatable camera in different directions. For instance, the camera is enabled to rotated in different directions using a motorized head. The images captured are stitched together to generate a high-resolution image called as panoramic image. The panoramic image is used in huge number of applications for example, video summarization, 3D image reconstruction, video stabilization.

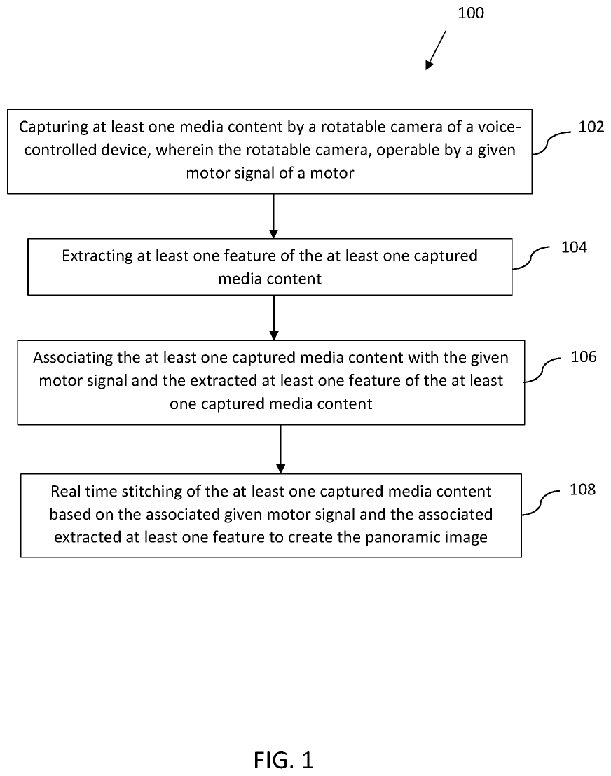

FIG. 1 illustrates the flow chart of the method of generating a real time panoramic image according to the preferred embodiment of the present invention. The method comprising: At Step (102), capturing at least one media content by a rotatable camera, optionally of a voice-controlled device, wherein the rotatable camera, operable by a motor signal of a motor. The media content is at least one of, but not limited to, an image, plurality of images and video. The rotatable camera, optionally of the voice-controlled device is enabled to capture at least one media content at a given motor signal wherein the rotatable camera is a 360 degrees rotatable camera. The given motor signal is configured to calculate the direction of motion of the rotatable camera. At Step (104), extracting at least one feature of the at least one captured media content. At Step (106), associating the at least one captured media content with the given motor signal and the extracted at least one feature of the at least one captured media content. At Step (108), the real time stitching of the at least one captured media content based on the associated given motor signal and the associated extracted at least one feature to create the panoramic image.

According to one exemplary embodiment of the present invention, the camera of the device is controlled via a motorized head for rotating the camera at a specific angle to capture at least one media content wherein the camera is a 360 degrees rotatable camera. The specific angle is at least one of the but not limited to 30 degrees, 45 degrees, 60 degrees, 90 degrees, 110 degrees, 135 degrees, 150 degrees, 180 degrees, 270 degrees and many more.

According to another exemplary embodiment of the present invention, a one or more user-provided instructions are configured to control the voice control device. The at least one or more user provided instructions relates to the predetermined angle of rotation for the rotatable camera or a field of view (FOV) angle for the rotatable camera.

In some embodiments, the method allows extraction of at least one feature of the at least one captured media content. The feature extraction of the at least one or more captured media content is at least of the but not limited to edges, corners, resolution, brightness, pixels and many more of the captured media content. The features are the elements in one or more media content to be matched while stitching of the one or more media content to generate the panoramic image.

According to another exemplary embodiment of the present invention the method allows the user of the device to easily generate panoramic images in cramped environments. Moreover the 360 degrees rotatable camera is configured to rotate along a vertical axis relative to the device, resulting in higher quality stitching of panoramic images.

According to another exemplary embodiment of the present invention the method comprises feature matcher for matching one or more features of the at least one or more captures media content (i.e. images, frames in video). A homography matrix is generated based on the number of the features matched. The homography matrix is reduced to x-directional translatory motion. The reduced homography matrix is then applied to the media content for generating the panoramic image.

According to another exemplary embodiment of the present invention the method uses slit scan approach for maintaining uniform exposure throughout the at least one captured media content while stitching to generate real time panoramic image. Further, in some embodiments the device is configured to transmit the real time panoramic image to a remote terminal for monitoring purposes.

According to one exemplary embodiment of the present invention the method of generating a real time panoramic image can be used variety of sectors. One use is in hospitality sector. The user could virtually drive through a resort area to see location and view using a panoramic image. This would provide the user better sense of the room, outdoor location of the hotel.

Another use is in bank sector for security and surveillance of the bank using real time generated panoramic image. The user of the device is enabled to monitor the inside and outside of the banks using the panoramic images. Another use is in retail sector for security and surveillance of the retail store. The user of the device is enabled to see 360 degrees view of the retail store via the panoramic image of the store. Further, the device enables the users to click 180 degrees panorama selfies with family or friends. Moreover, the method of the device generates real time panoramic images for feature less objects.

Another use is in healthcare sector for giving doctors the liberty to continuously monitor their patients using the real time generated panoramic images. Moreover, the method is applicable generally to tasks which require panoramic monitoring of a given or large area. The real time panoramic image generated by the device enables for traffic monitoring and control, especially at major road intersections, airport surveillance i.e. panoramic monitoring of an airfield from a control tower, in ships and aircraft carriers, mounted on a mast to provide a panoramic view of decks, remote monitoring of industrial processes.

It will be apparent from this list that although specific embodiments of the present invention are illustrated and described in this specification, modifications of those embodiments may be made without departing from the present invention concept.

1. A method of generating a real time panoramic image comprising:
capturing at least one media content by a rotatable camera, wherein the rotatable camera, operable by a motor signal of a motor, is enabled to capture at least one media content at a given motor signal;
at least one sensor coupled with camera enabled to transmit information to at least one processor in response to detecting of movement of the object;
wherein the processor is configured to generate a motor signal, in accordance with the received information, enabled to be transmitted to the motor indicating a rotational angle and direction of movement of the camera according to the information provided by sensors;
and the motor is configured to rotate the camera according to the given motor signal;
extracting at least one feature of the at least one captured media content;
associating the at least one captured media content with the given motor signal and the extracted at least one feature of the at least one captured media content; and
a real time stitching of the at least one captured media content based on the associated given motor signal and the associated extracted at least one feature to create the panoramic image.

2. The method of claim 1, wherein the at least one media content is at least one of an image, video.

3. The method of claim 1, wherein at least one or more media content is captured by the rotatable camera.

4. The method of claim 1, wherein the camera is a 360 degrees rotatable camera.

5. The method in accordance with claim 5, further comprising: controlling the camera via a motorized head for rotating the camera at a specific angle.

6. The method of claim 1, wherein the motor signal is configured to calculate a direction of motion of the camera.

7. The method of claim 1, wherein the rotatable camera is of a voice-controlled device.
